(19) United States
(12) Patent Application Publication
(10) Pub. No.: US 2005/0044529 A1
(43) Pub. Date: Feb. 24, 2005

(54) Task library of task data for a plurality of components on a computer system

(75) Inventors: Joyce C. Simons, Kirkland, WA (US); John M. Tippett, Seattle, WA (US); Marieke Iwema, Seattle, WA (US); Ann Colleen Dunham, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/644,656

(22) Filed: Aug. 20, 2003

(51) Int. Cl. G06F 9/44

(52) U.S. Cl. 717/120; 717/174; 717/163

(57) ABSTRACT

A task library comprising task data for a plurality of components installed on a computer system is provided. The task library includes task data for a plurality of components installed on a computer system. The task links, that reference task data elements, are generated and stored with the task library. The task links are generated according to predetermined schemas associated with the task library. Task data elements may be configured such that the installed component corresponding to the task data may be manipulated/configured from within the context of the task library. The components installed on the computer may be hardware or software components. Installed components may include modules that are “installed” on the computer though they are located remote to the computer.

### FIELD OF THE INVENTION

The present invention relates to computer reference information, and in particular, a task library comprising task data relating to a plurality of components installed on a computer system, the task data identifying tasks that may be performed on the computer system.

### BACKGROUND OF THE INVENTION

Computer systems are made up of numerous hardware and software components, collectively operating to create the computer system. However, while computer systems have become increasingly more powerful, they still require computer users to think in terms of distinct, separate components, including both hardware and software components. Thus, for a user to perform a specific task, the user must think in terms of a particular component to accomplish that task, instead of the whole, cooperative computer system. This componentization of specific tasks is often quite challenging to computer users, particularly to inexperienced computer users. These challenges are heightened as the computer user must also know which component accomplishes a specific task.

At least some of these componentization problems arises because the various components that make up a computer system come from a variety of vendors. Almost always, operating system and application vendors provide some form of reference material, or help, regarding the supplied components, but they almost never provide information beyond the scope of the supplied components. For example, a text editor application may include a help system that provides information regarding how to print a document from within the text editor component. However, should a problem arise while attempting to print the document, and that problem appears to be outside of the text editor's control, the component can, at best, only suggest that the computer user refer to some other component's help system. The computer user is then left to discover which, of all the components on the system, are involved with printing the document, and also determine which other component is not functioning, or is configured incorrectly. If the computer user is able to identify the proper component, the computer user must switch application context from the text editor to the “offending” component to make the necessary corrections. Once there, the computer user must determine how to make the necessary changes by navigating through that component's user interface, including menus, custom controls, toolbars, dialogs, and the like. Once the location is found and the problem corrected, the user must then return back to the text editor application to complete the print operation, requiring yet an additional context switch. Clearly, to the computer user, simply printing a document may be very challenging.

What is needed in the prior art is a task library containing information relating to the abilities of a computer system. The task library should include information for a plurality of components installed on or available to a computer system. The information for the plurality of components available to the computer system should be organized to facilitate user access to similar and/or related topics, even among multiple components on the computer system. The present invention addresses these an other deficiencies of the known art.

### SUMMARY OF THE INVENTION

A task library comprising reference information (task data) from multiple components installed on a computer is provided. The components may include both hardware and software components. The components may be local or remote to the computer. The task library includes links referencing the task data, wherein the links are generated according to predetermined schemas, such as predefined categories, or alphabetically by subject matter. The task data may include at least one task data element, i.e., individual entries in the task data, that is configured such that aspects of a corresponding component may be modified from within the context of the task library.

In accordance with other aspects of the present invention, a method for creating a task library is presented. Task data from a plurality of components installed on a computer is obtained. The task data may include at least one task data element that is configured such that aspects of a corresponding component may be modified from within the context of the task library. Task links referencing the task data from the plurality of components are generated according to a predetermined schema, such as predefined categories or subjects, or alphabetically by subject matter. The task data and the task links are stored as the task library.

In accordance with further aspects of the present invention, a method for executing a task in the task library without change component context from the current context is presented. Tasks from a task library are retrieved. The task library comprises a plurality of tasks from a plurality of components installed on the computer. The retrieved tasks are displayed to the user. A user selection of a retrieved task is detected and the actions associated with the retrieved task are carried out.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary computer system suitable for implementing aspects of the present invention;

FIG. 2 is a pictorial diagram illustrating the installation of components into a computing system in accordance with the prior art;

FIG. 3 is a pictorial diagram illustrating the installation of components into a computing system in accordance with embodiments of the present invention;

FIG. 4 is a pictorial diagram illustrating an exemplary user interface screen to the task library, viewing task data stored in the task library according to a schema of predetermined categories;

FIG. 5 is a pictorial diagram illustrating an exemplary user interface screen to the task library, illustrating tasks linked under the Security and Maintenance category shown in FIG. 4;

FIG. 6 is a pictorial diagram illustrating an exemplary user interface screen to the task library, viewing task data stored in the task library according to an alphabetic schema of main topics;

FIGS. 7A, 7B, and 7C are a pictorial diagrams illustrating an exemplary user interface screen of a picture library in conjunction with displaying tasks from the task library;

FIG. 8 is a flow diagram illustrating an exemplary method for creating a task library on a computing system; and

FIG. 9 is a flow diagram illustrating an exemplary routine for executing a tasks in a task library.

### DETAILED DESCRIPTION

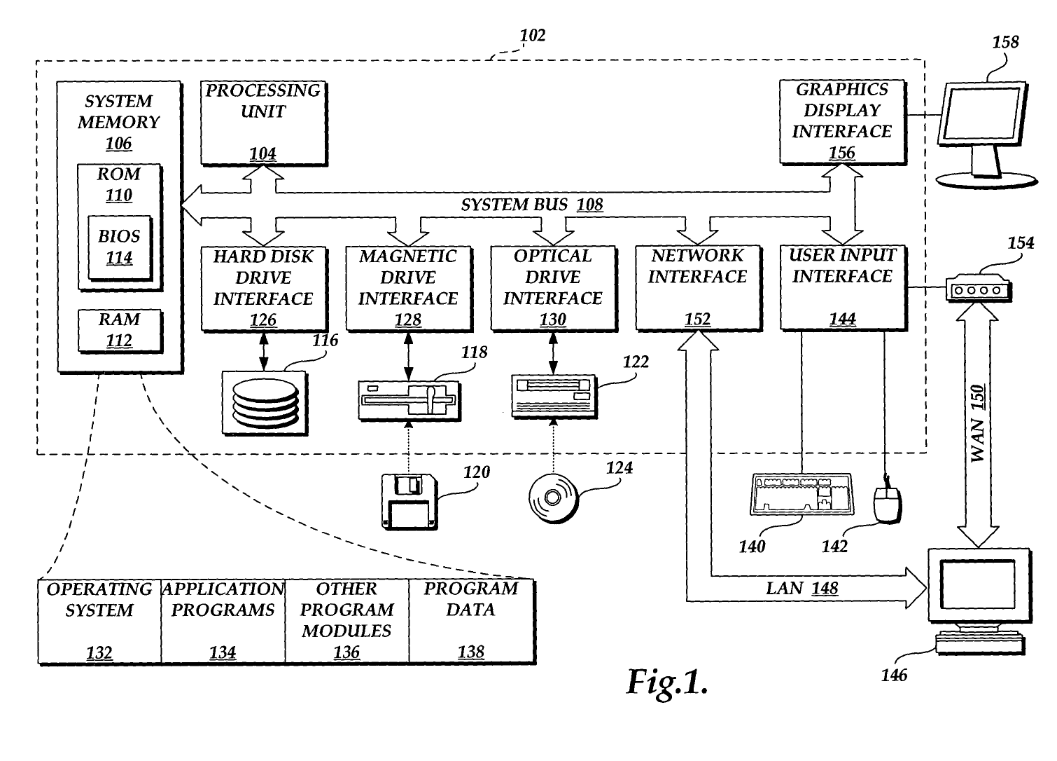

FIG. 1 and the following discussion are intended to provide a brief, general description of a computing system suitable for implementing various features of the invention. While the computing system will be described in the general context of a personal computer usable in a standalone computing environment, or in a distributed computing environment, where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, personal digital assistants (PDAs), and other devices upon which software and hardware components, and corresponding reference data, are installed.

While aspects of the invention may be described in terms of application programs that run on an operating system in conjunction with a personal computer, those skilled in the art will recognize that those aspects also may be implemented in combination with other program modules. Generally, program modules include routines, programs, components, data structures, etc., that perform particular tasks or implement particular abstract data types.

With reference to FIG. 1, an exemplary system for implementing aspects of the invention includes a conventional personal computer 102, including a processing unit 104, a system memory 106, and a system bus 108 that couples the system memory to the processing unit 104. The system memory 106 includes read-only memory (ROM) 110 and random-access memory (RAM) 112. A basic input/output system 114 (BIOS), containing the basic routines that help to transfer informiation between elements within the personal computer 102, such as during startup, is stored in ROM 110.

The personal computer 102 further includes a hard disk drive 116, a magnetic disk drive 118, e.g., to read from or write to a removable disk 120, and an optical disk drive 122, e.g., for reading a CD-ROM disk 124 or to read from or write to other optical media. The hard disk drive 116, magnetic disk drive 118, and optical disk drive 122 are connected to the system bus 108 by a hard disk drive interface 126, a magnetic disk drive interface 128, and an optical drive interface 130, respectively. The drives and their associated computer-readable media provide nonvolatile storage for the personal computer 102. Although the description of computer-readable media above refers to a hard disk, a removable magnetic disk, and a CD-ROM disk, it should be appreciated by those skilled in the art that other types of media that are readable by a computer, such as magnetic cassettes, flash memory cards, digital video disks, Bernoulli cartridges, ZIP disks, and the like, may also be used in the exemplary operating environment.

A number of program modules may be stored in the drives and RAM 112, including an operating system 132, one or more application programs 134, other program modules 136, and program data 138. A user may enter commands and information into the personal computer 102 through input devices such as a keyboard 140 or a mouse 142. Other input devices (not shown) may include a microphone, touch pad, joystick, game pad, satellite dish, scanner, or the like. These and other input devices are often connected to the processing unit 104 through a user input interface 144 that is coupled to the system bus, but may be connected by other interfaces (not shown), such as a game port or a universal serial bus (USB). A display device 158 is also connected to the system bus 108 via a display subsystem that typically includes a graphics display interface 156 and a code module, sometimes referred to as a display driver, to interface with the graphics display interface. While illustrated as a stand-alone device, the display device 158 could be integrated into the housing of the personal computer 102. Furthermore, in other computing systems suitable for implementing the invention, such as a PDA, the display could be overlaid with a touch-screen. In addition to the elements illustrated in FIG. 1, personal computers also typically include other peripheral output devices (not shown), such as speakers or printers.

The personal computer 102 may operate in a networked environment using logical connections to one or more remote computers, such as a remote computer 146. The remote computer 146 may be a server, a router, a peer device, or other common network node, and typically includes many or all of the elements described relative to the personal computer 102. The personal computer 102 may be logically connected to other remote devices, such as network printers and fax machines (not shown). The logical connections depicted in FIG. 1 include a local area network (LAN) 148 and a wide area network (WAN) 150. Such networking environments are commonplace in offices, enterprise-wide computer networks, intranets, and the Internet. It should be appreciated that the connections between one or more remote computers in the LAN 148 or WAN 150 may be wired or wireless connections, or a combination thereof.

When used in a LAN networking environment, the personal computer 102 is connected to the LAN 148 through a network interface 152. When used in a WAN networking environment, the personal computer 102 typically includes a modem 154 or other means for establishing communications over the WAN 150, such as the Internet. The modem 154, which may be internal or external, is connected to the system bus 108 via the user input interface 144. In a networked environment, program modules depicted relative to the personal computer 102, or portions thereof, may be stored in the remote memory storage device. It will be appreciated that the network connections shown are exemplary and other means of establishing a communication link between the computers may be used. In addition, the LAN 148 and WAN 150 may be used as a source of nonvolatile storage for the personal computer 102.

As illustrated in FIG. 1, the personal computer 102 is comprised of numerous cooperating devices, modules, peripherals, services, etc., all of which may be collectively referred to as components, both hardware and software, most of which come from a variety of vendors. As previously mentioned, in addition to those components that are part of, or physically connected to, the personal computer 102, other components may be installed on the computer that are remote to the computer, but accessible over a logical network connection. For purposes of the present discussion, an installed component is a component that is installed on, or accessible to a computer system, such as the personal computer 102, whether the component is physically or logically connected to the computer system.

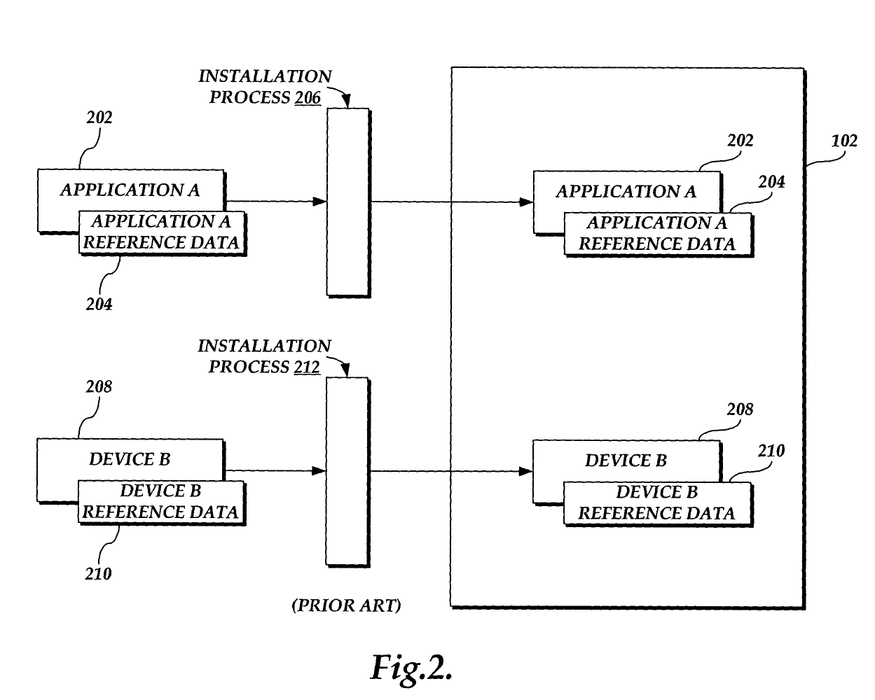

FIG. 2 is a pictorial diagram illustrating the installation of components onto a computing system, such as the personal computer 102, in accordance with the prior art. As illustrated in FIG. 2, two components are being installed on the computing system 102: software component Application A 202, and hardware component Device B 208. Accompanying Application A 202 is the reference data Application A Reference Data 204, and accompanying Device B 208 is the reference data Device B Reference Data 210. Reference data, as known in the prior art, typically includes help-style instructions and information that describes various aspects of a component, such as how a feature works, how it may be used, or how the component may be configured. Reference data also sometimes includes hyperlinks to other related material within the set of reference data or, alternatively, to related content stored elsewhere, such as on a Web page on the Internet. Typically, reference data is self-contained, meaning that it functions as a separate module from the reference data of other components installed on the same computer system. Thus, Application A Reference Data 204 and Device B Reference Data 210 are separate modules, unaware of each other, and, even should they contain reference material relating to a common topic, they would not cross-reference each other.

As illustrated in FIG. 2, Application A 202 is installed onto the computer system 102 with Application A Reference Data 204 via an installation process 206. Installation processes are known in the art. Similarly, Device B 208 is installed onto the computer system 102, with Device B Reference Data 210, via an installation process 212. As reference data is typically only accessed by the corresponding installed component, such reference data is typically installed in close proximity to the component, such as within the same installation directory area. Thus, Application A Reference Data 204 and Device B Reference Data 210 are illustratively shown in FIG. 2 in close proximity to their corresponding components.

As will be readily recognized by those skilled in the art, the installation process for a hardware component, such as installation process 212 for Device B 208, may be substantially different from the installation process of a software component, such as installation process 206 for Application A 202. However, those skilled in the art will also recognize that installing a hardware component often requires some installation, or activation, of controlling software on the computer system 102, often referred to as a device driver. It is typically during the installation of a device driver for a hardware component that available reference material, such as Device B Reference Data 210, is placed on the computer system 102.

Also shown in FIG. 2, as components are installed onto the computer system 102, a collection of unrelated reference systems are installed onto the computer system. As described above, while the necessary information may be found among the unrelated reference systems, a user may find it challenging to locate such information from among the various unrelated reference systems. In fact, because the reference systems are independent of each other, such as Application A Reference Data 204 and Device B Reference Data 210, a computer user may not be able to determine that the sought-for information exists on the computer system 102. In contrast, the present invention provides a reference system wherein reference data from a plurality of components installed on the computer system 102 are located within a single task library.

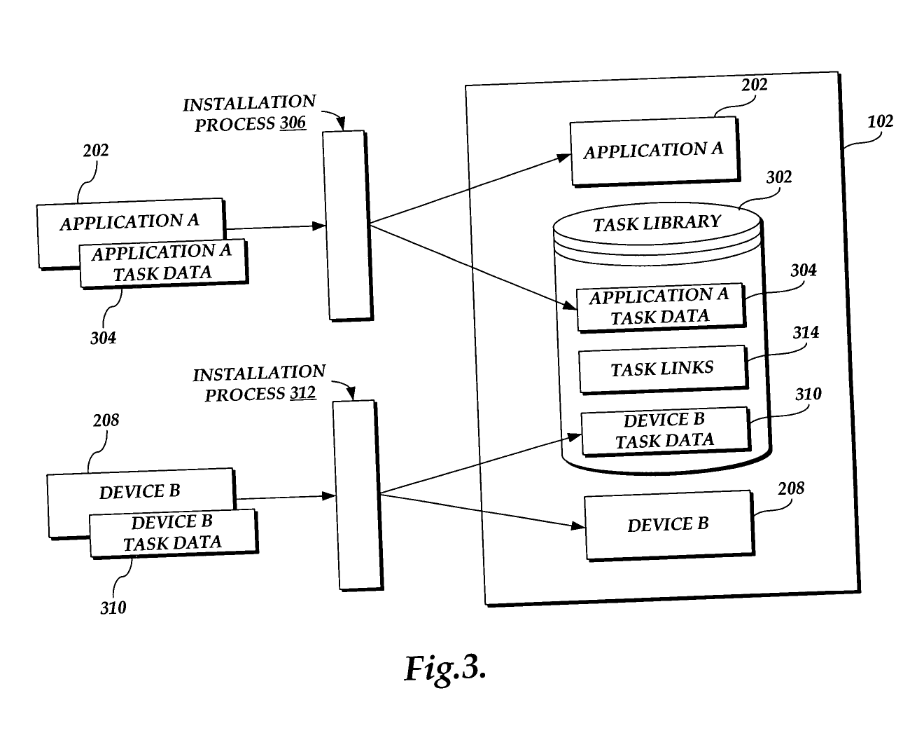

FIG. 3 is a pictorial diagram illustrating the installation of components onto a computer system, such as the personal computer 102 of FIG. 1, in accordance with embodiments of the present invention. According to the present invention, the computer system 102 includes a task library 302 for providing a common repository for reference data corresponding to installed components on the computer system. The task library 302 may be viewed as a system-wide, unified help system, integrating reference data for multiple installed components into a single library, or database, of information. According to one embodiment, a task library 302 is provided with the operating system and includes reference data from the various operating system components. Other applications/components, as they are installed on the computer, may also include reference data that is incorporated into the task library 302. Thus, information in the task library 302 may include reference data relating to components including the operating system, installed applications, installed hardware devices, network services, local and network printers, and the like.

Typically, reference data is added to the task library 302 concurrently with the installation of the corresponding component. As illustrated in FIG. 3, Application A 202 and its associated reference data, Application A Task Data 304, are installed on the computer system 102 via an updated installation process 306. The installation process 306 is updated from the prior art such that, while a component is installed on the computer system 102 in a typical manner known in the art, the corresponding reference data, such as Application A Task Data 304, is stored in the task library 302. Similarly, Device B 202, and its associated reference data Device B Task Data 310, are installed on the computer system 102 by an updated installation process 312, with the Device B Task Data 310 stored in the task library 302. It should be understood that while FIG. 3 illustrates that reference data is added concurrently with a corresponding component, it is for illustration purposes only. Reference data, such as Application A Task Data 304 or Device B Task Data 310, may be added at any time to the task library 302. Accordingly, the present invention should not be construed as limited to adding reference data to the task library 302 only during an installation process.

When reference data is added to the task library 302, task links 314 are generated and/or updated to include references to the added reference data. Task links 314 are pointers or references to individual reference units of the reference data. The task links 314 enable a user to efficiently access the reference material in the task library 302. These task links 314 are generated according to one or more schemas associated with the task library 302. The task links 314 may include links generated according to multiple schemas. Task links 314 are commonly stored with or in the task library 302.

Task links 314 may be viewed as a type of table of contents or index to the reference data in the task library 302, depending on the schema used to generate the links. For example, task links 314 may be generated to point to the reference data in the task library 302 according to sections and chapters. Alternatively, or additionally, task links 314 may be generated to point to the reference data according to the topics or subject matter of the individual reference entries. As yet another alternative, task links 314 may be generated to reference the data in an alphabetic order according to each entry's subject matter. Categories within the task links may include subcategories thereby creating a nested structure of topics and subtopics, as well as the individual reference entries. Numerous alternative schemas for generating task links 314 within the task library 302 are contemplated as falling within the scope of the present invention.

As shown in FIG. 3, the reference data to be stored in the task library 302, such as Application A Task Data 304 and Device B Task Data 310, is not the same data as the reference data mentioned above in regard to FIG. 2, such as Application A Reference Data 204 and Device B Reference Data 210. Reference data that is stored in the task library 302, hereafter referred to as task data, may include information not found in the prior art. The individual task data entries, i.e., individual units in the task data, may include information, or metadata, that enable a computer user to perform or complete specific tasks relating to a corresponding component from within the context of the task library 302. For example, upon locating a specific task data entry in the task library 302 relating to printer configuration options, rather than requiring the user to switch context to a printer configuration module, the task data entry may present the user with the ability to immediately adjust the printer's configuration values, from within the context of the task library 302. Thus, in contrast to the prior art, the user is not required to switch context from the task library 302 to the printer related configuration module in order to adjust specific values.

Task data entries may alternatively include information that enables a user to launch a program on the computer system 102, send a message to another user or remote system, open additional assistance materials, navigate to Web pages, and the like, all from within the context of the task library 302. Other actions may also enabled by the task data entries from within the task library 302, and these are also contemplated as falling within the scope of the present invention.

Task data in a task library 302 may be configured in such a way as to be context sensitive, including responsive to a user's identity and/or permissions, current computer system status, recent user actions, and the like. For example, task data may be configured such that only certain identified users, or groups of users, may access particular, restricted task data. Alternatively, task data may be configured to be accessible only to task library 302 users having specific system access permissions, such as read/write permissions, or administrator privileges. A user may be able to access the task library 302 directly, i.e., at a top level, in order to browse the task data via the generated task links 314, or in relation to a particular topic. For example, while attempting to print a document from a word processing application/component, the task library 302 may be invoked/entered such that the user is taken directly to related printing task data. Other means for accessing the task library 302 may also be utilized.

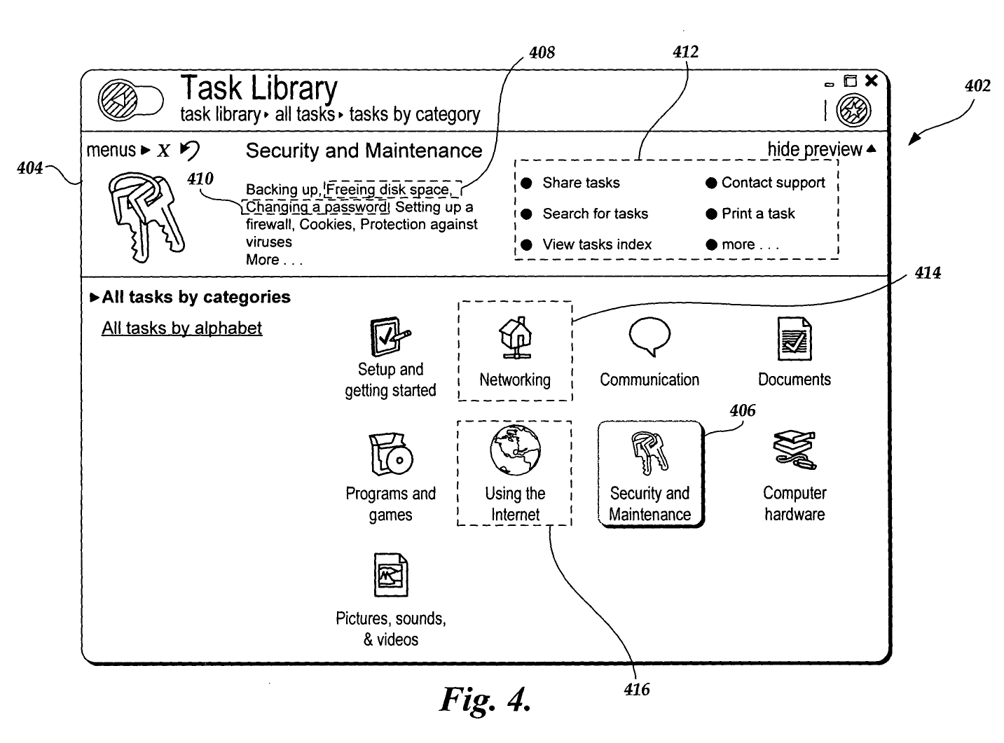

FIG. 4 is a pictorial diagram illustrating an exemplary user interface screen 402 for accessing an exemplary task library 302, viewing the task data stored in the task library according to a schema of predetermined categories. As shown in the exemplary user interface screen 402, the Security and Maintenance Category 406 has been selected. A preview pane 404 illustrates several options available for, and defined within, the Security and Maintenance Category 406, including Freeing Disk Space 408 and Changing a Password 410. Other options, including tasks 412, i.e., actions that may be taken within the task library 302 in regard to a corresponding component, are also present in the preview pane 404.

Because the task library 302 combines task data from multiple installed components into a unified body, each predetermined category may include task data from a plurality of installed components on the computer system 102. For example, task data referenced under the Security and Maintenance Category 406 may include entries corresponding to an on-computer password security component as well as information regarding an installed network firewall component. Additionally, a single task data entry may be linked to, and presented in, more than one predetermined category. Thus, while a task data entry relating to an installed network firewall component may be found under the Security and Maintenance Category 406, it may also be found under the Networking Category 414, and/or the Using the Internet Category 416, to name just a few.

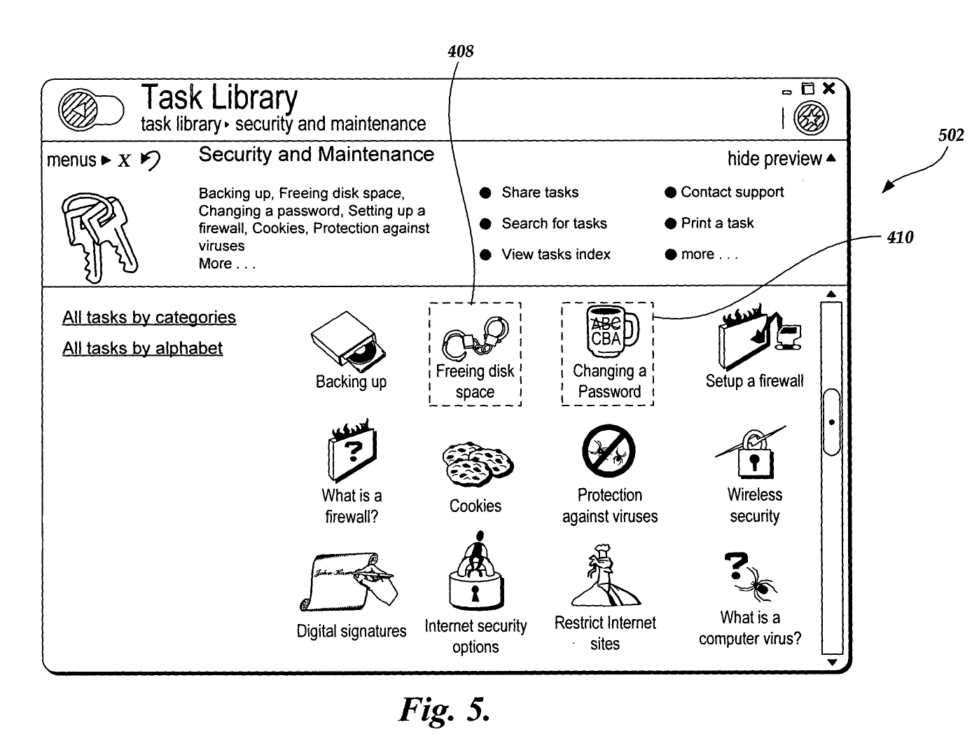

FIG. 5 is a pictorial diagram illustrating an exemplary user interface screen 502 to the task library 302, illustrating tasks in the task library associated with the Security and Maintenance category 406 shown in FIG. 4. As illustrated, those tasks associated with the Security and Maintenance category 406, that are displayed in the preview pane 404 (FIG. 4), including Freeing Disk Space 408 and Changing a Password 410, are displayed on the user interface screen 502 along with other tasks and subcategories associated with this category. Each category, or subcategory, in a task library may have links to both tasks and other subcategories.

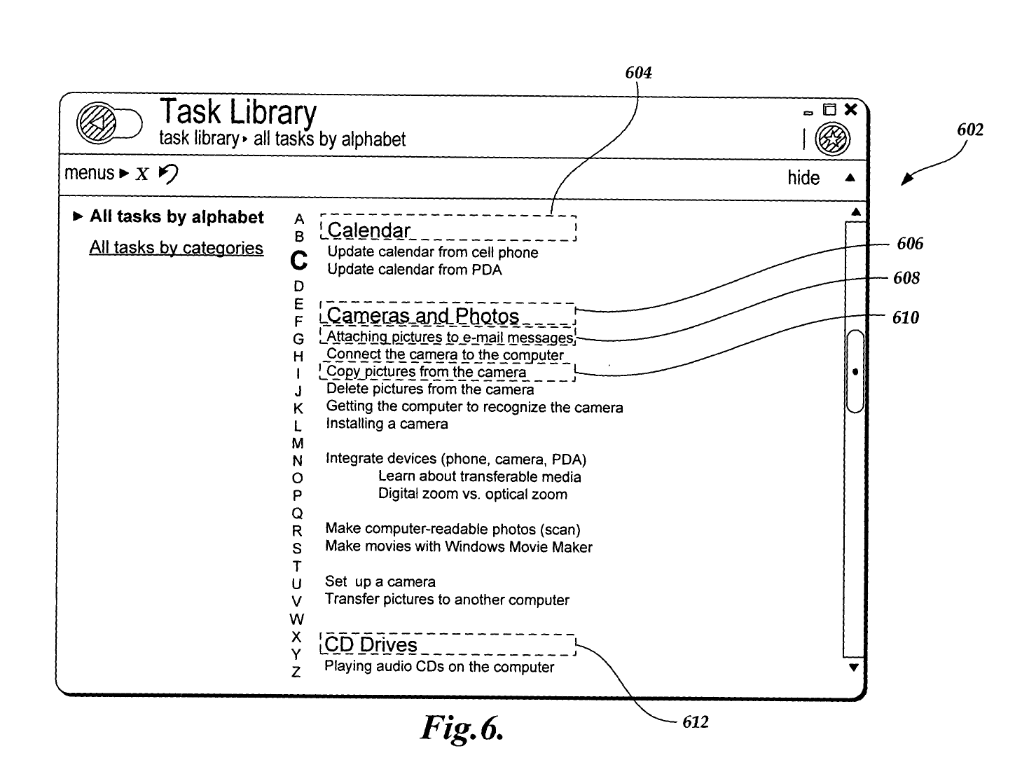

FIG. 6 is a pictorial diagram illustrating an exemplary user interface screen 602 to the task library 302, viewing the task data stored in the task library according to an alphabetic schema of main topics. For example, the exemplary user interface screen 602 illustrates some of the main topics available: Calendar 604, Cameras and Photos 606, and CD Drives 612. Organized under the main topics include both sub-topics and task data entries relating to the respective main topics. The task data entries under each main topic may correspond to task data from multiple installed components. For example, under the main topic Cameras and Photos 606, task data entry Attaching Pictures to E-Mail Messages 608 may correspond to an e-mail service installed on the computer 102, while the task data entry Copy Pictures From the Camera 610 may have been provided, and correspond to, a digital camera installed on the computer.

As mentioned above, according to one aspect of the present invention, task data entries may be delivered in a format such that a user may carry out particular instructions or tasks not available with current reference or help systems, from within the task library 302, i.e., while browsing the task data entries in the task library. Thus, with reference to FIG. 6, if a user wishes to copy pictures to the computer from a digital camera, that user could select the task data entry Copy Pictures From the Camera 610, whereupon the user may be presented with an interface screen describing what to do, or more advantageously, facilitating the user to copy one or all of the pictures from the camera to the computer 102 while the user's context remains in the task library 302.

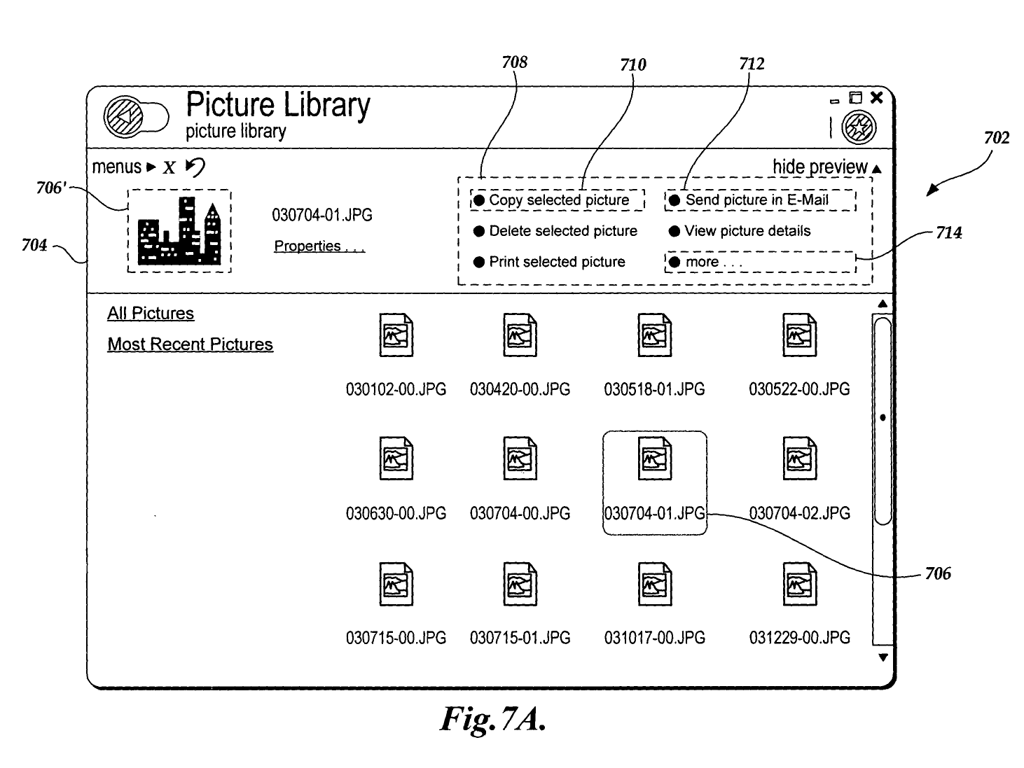

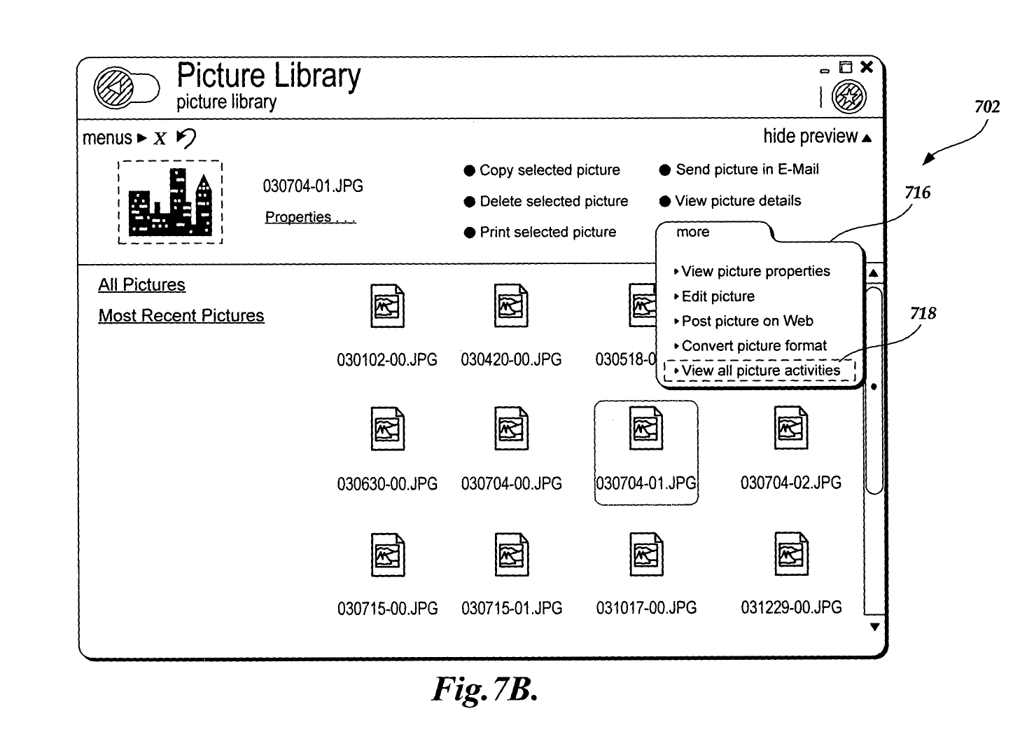

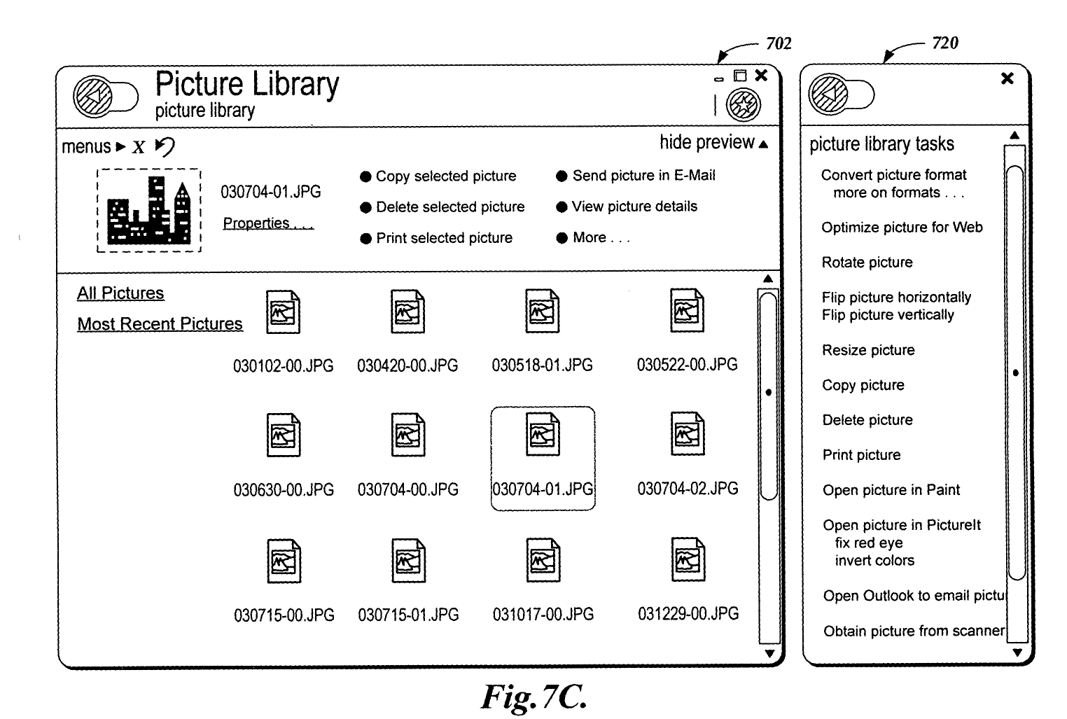

FIG. 7A is a pictorial diagram illustrating an exemplary user interface screen 702 of a picture library in conjunction with displaying tasks from the task library 302. As illustrated, Picture 706 has been selected. As typical of viewers of a picture library, the user interface screen 702 includes a preview pane 704 where a thumbnail image 706′ of Picture 706 is displayed. Also shown in the preview page 704 are tasks 708 from a task library 302, including Copy Selected Picture 710 and Send Picture in E-Mail 712. These associated tasks 708 have been selected according to the current context of the user interface screen 702.

According to aspects of the present invention, in addition to selecting tasks from the task library 302 according to the current context, the selected tasks may be presented to a user in such a way as to put certain tasks in more prominent or accessible locations according to a determined relevancy. For example, the tasks 708 prominently displayed in the preview pane 704 may have been selected because they were considered most relevant. Relevancy for tasks may be determined according to a number of factors, including, but not limited to, current computer state information, the frequency with which the user selects a certain task, the frequency that others select a certain task, and the like. Relevancy information may be stored with the task library 302.

As previously mentioned, tasks in a task library 302 may not necessarily be implemented by the current component. Thus, the picture library component that presents the user interface screen 702 to the user might not implement any of the associated tasks in the preview pane 704, such as Copy the Selected Picture 710. Additionally, tasks in the task library 302 may be configured such that they may complete the associated function without changing from the current component's context. Thus, while the component that displays the picture library 702 may not have the functionality to send the Picture 706 to another person via e-mail, a user may, nonetheless, be able to send the Picture 706 without changing from the current component's context by selecting the task Send Picture in E-Mail 712.

The associated tasks 708 in the preview pane 704, such as Copy Selected Picture 710 and Send Picture in E-Mail 712, are presented because picture 706 has been selected. This is an example of how the task library 302 may be accessed in a context sensitive manner. For example, the component that present the user interface screen 702 is aware of the current context, in this case Picture 706 is selected. Thus, in presenting the associated tasks 708, this component likely requested information from the task library 302 according to the categories defined in the task library. Because there is a limited amount of space in a preview pane 704 to display related tasks, in one embodiment, tasks are selected to be displayed in a preview pane according to those that the component deems most likely to be used. Additional related tasks that are less commonly used may also be accessed. For example, by selecting the task More 714, additional associated tasks may be presented.

FIG. 7B is a pictorial diagram illustrating the exemplary user interface screen 702 of a picture library in conjunction with displaying tasks from the task library 302, after the task More 714 has been selected. As shown in FIG. 7B, additional tasks associated with pictures and/or picture libraries are found in the drop-down menu control 716. As can be seen in the drop-down menu control 716, yet other associated tasks may be made available by selecting the task View All Picture Activities 718.

FIG. 7C is a pictorial diagram illustrating the exemplary user interface screen 702 of a picture library in conjunction with displaying tasks from the task library 302, after the task View All Picture Activities 718 (FIG. 7B) is selected in the drop-down menu control 716 (FIG. 7B). As show in this diagram, tasks from the task library 302 may be displayed in a separate task window 720. According to aspects of the present invention, because the display of tasks is context sensitive to the current computer context, only tasks associated with pictures are displayed in the task window 720.

It should be understood that while the above figures illustrate various user interface mechanisms for accessing tasks in a task library 302, they are for illustration purposes only, and should not be construed as limiting upon the present invention. Those skilled in the art will recognize that numerous other user interface controls may be used without departing from the scope of the present invention.

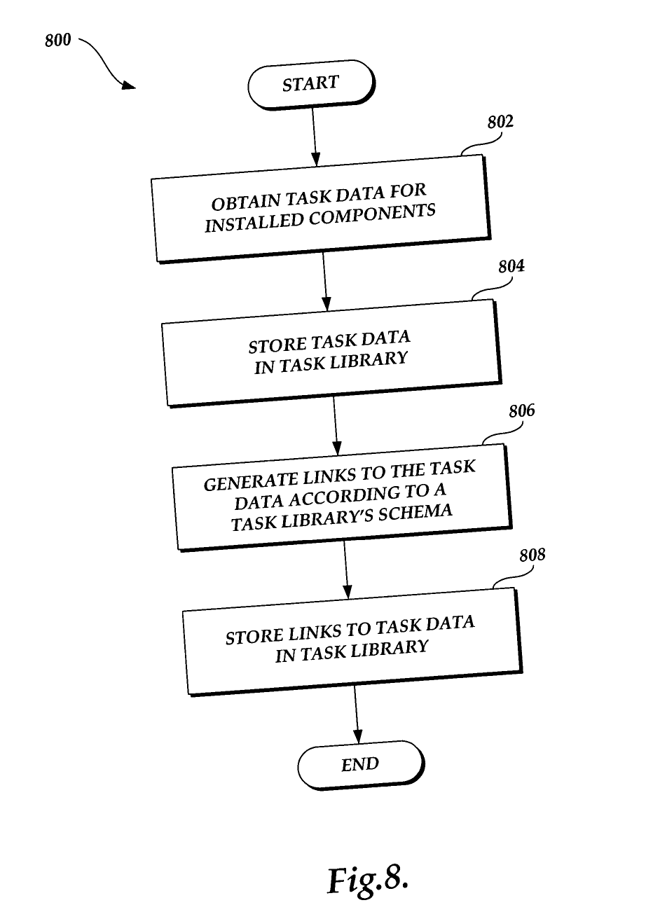

FIG. 8 is a flow diagram illustrating an exemplary routine 800 for creating a task library 302 on a computer 102. Beginning at block 802, task data corresponding to a plurality of components installed on the computer is obtained. As previously mentioned, these components include both hardware and software components. For example, task data may be obtained from the operating system, installed applications and services, networking interfaces, printers, and the like. The task data may be from components located on the computer 102, directly linked to the computer, or remotely located from the computer.

At block 804, the task data from the plurality of components is stored in a task library 302. According to one aspect of the present invention, the task library 302 is a database stored on the computer 102. Other storage configurations of a task library 302 may also be utilized. The task library 302 may be stored remote from the computer 102, such as on a remote computer 146 or on the Internet. Accordingly, the present invention should not be construed as limited to any particular configuration. At block 806, task links 314 referencing the task data entries in the task library 302 are generated according to at least one predetermined schema associated with task library. At block 808, the task links 314 are stored as part of the task library 302. Thereafter, the routine 800 terminates.

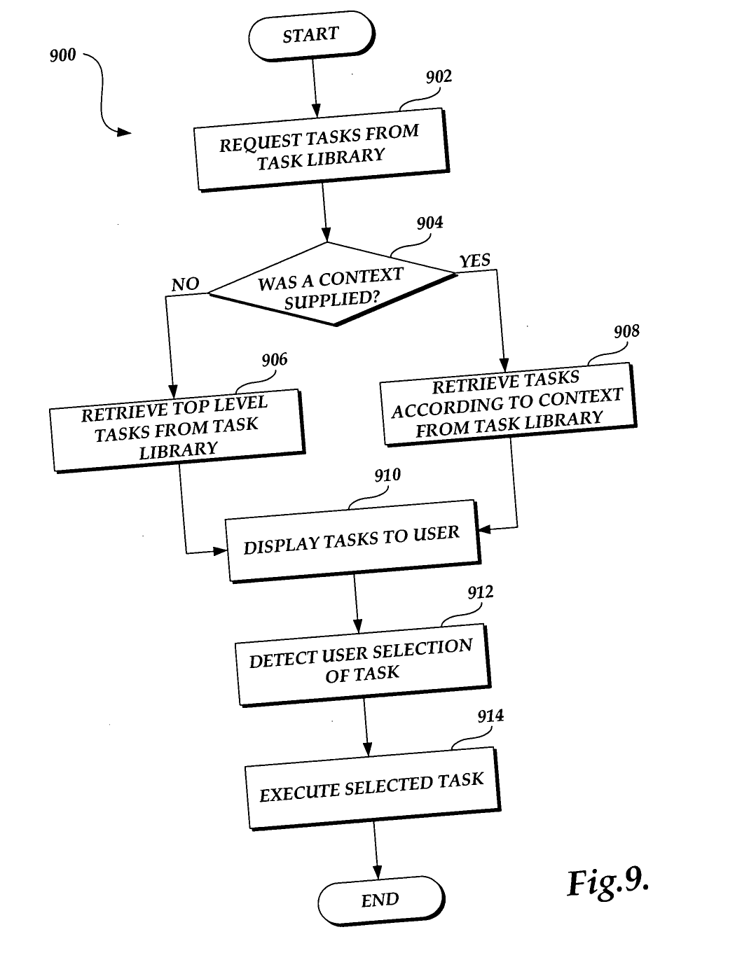

FIG. 9 is a flow diagram illustrating an exemplary routine 900 for executing a tasks in a task library 302. Beginning at block 902, a request is made for tasks from the task library 302. At decision block 904, a determination is made as to whether the request supplied a context for the retrieved tasks. If the request did not supply a context for the requested tasks, at block 906, top level tasks from the task library are retrieved. It should be understood that the retrieved tasks may be executable task data entries, information, or categories referencing other tasks. Alternatively, if the request did supply a context for the requested tasks, at block 908, tasks are retrieved from the task library 302 according to the supplied context.

At block 910, the retrieved tasks are displayed to a user. Examples of how tasks may be displayed to a user are found in FIGS. 4, 5, 6, 7A, and 7B. Other means for displaying the tasks to a user may also be used. At block 912, a selection of a displayed task is detected. At block 914, the selected task is executed. Thereafter, the routine 900 terminates. Executing a task may include carrying out associated actions with a different component, displaying reference information, or displaying a subcategory of tasks, depending of course on the type of task selected, as described above.

While embodiments of the invention have been illustrated and described, including the preferred embodiment, it will be appreciated that various changes can be made therein without departing from the spirit and scope of the invention.

1. A method for creating a task library on a computer, comprising:
obtaining task data for a plurality of components installed on the computer;
generating task links referencing the task data for the plurality of components according to a predetermined schema; and
storing the task data and the task links as the task library.

2. The method of claim 1, wherein the plurality of components installed on the computer comprises at least one hardware component.

3. The method of claim 1, wherein the plurality of components installed on the computer comprises at least one software component.

4. The method of claim 3, wherein the plurality of components installed on the computer comprises operating system components.

5. The method of claim 1, wherein the plurality of components installed on the computer comprises at least one hardware component and at least one software component.

6. The method of claim 1, wherein the plurality of components installed on the computer comprises at least one remote component.

7. The method of claim 1, wherein the plurality of components installed on the computer are from a plurality of component providers.

8. The method of claim 1, wherein the predetermined schema organizes the task links referencing the task data according to predetermined topics.

9. The method of claim 1, wherein the predetermined schema organizes the task links referencing the task data according to an alphabetic ordering of the subject matter of the task data.

10. The method of claim 1, wherein the task data comprises reference information to assist a user in regard to the corresponding component.

11. The method of claim 10, wherein the task data further comprises a plurality of tasks, and wherein each task corresponds to a particular topic relating to its corresponding component.

12. The method of claim 11, wherein a task of the task data is configured such that the corresponding component may be manipulated from within the task library.

13. A task library accessible to a computer, comprising:
task data for a plurality of components installed on the computer; and
task links referencing the task data generated according to a predefined schema.

14. The task library of claim 13, wherein the plurality of components installed on the computer comprises at least one hardware component.

15. The task library of claim 13, wherein the plurality of components installed on the computer comprises at least one software component.

16. The task library of claim 15, wherein the plurality of components installed on the computer comprises operating system components.

17. The task library of claim 13, wherein the plurality of components installed on the computer comprises at least one hardware component and at least one software component.

18. The task library of claim 13, wherein the plurality of components installed on the computer comprises at least one remote component.

19. The task library of claim 13, wherein the plurality of components installed on the computer are from a plurality of component providers.

20. The task library of claim 13, wherein the predefined schema organizes the task links referencing the task data according to predefined topics.

21. The task library of claim 13, wherein the predefined schema organizes the task links referencing the task data according to an alphabetic ordering of the subject matter of the task data.

22. The task library of claim 13, wherein the task data comprises reference information to assist a user in regard to the plurality of components installed on the computer.

23. The task library of claim 22, wherein the task data further comprises a plurality of tasks, wherein each task corresponds to a particular topic relating to one of the plurality of components installed on the computer.

24. The task library of claim 23, wherein the task data comprises at least one task configured such that aspects of a corresponding component installed on the computer may be manipulated from within the task library.

25. A computer system comprising:
a processor;
a memory storing a task library, the task library comprising:
task data for a plurality of components installed on the computer system; and
task links referencing the task data generated according to a defined schema.

26. The computer system of claim 25, wherein the plurality of components installed on the computer system comprises at least one hardware component.

27. The computer system of claim 25, wherein the plurality of components installed on the computer system comprises at least one software component.

28. The computer system of claim 27, wherein the plurality of components installed on the computer system comprises operating system components.

29. The computer system of claim 25, wherein the plurality of components installed on the computer system comprises at least one hardware component and at least one software component.

30. The computer system of claim 25, wherein the plurality of components installed on the computer system comprises at least one remote component.

31. The computer system of claim 25, wherein the plurality of components installed on the computer system are from a plurality of component providers.

32. The computer system of claim 25, wherein the predefined schema organizes the task links referencing the task data according to predefined topics.

33. The computer system of claim 25, wherein the predefined schema organizes the task links referencing the task data according to an alphabetic ordering of the subject matter of the task data.

34. The computer system of claim 25, wherein the task data for the plurality of components installed on the computer system comprises reference information to assist a user in regard to the plurality of components.

35. The computer system of claim 34, wherein the task data further comprises a plurality of tasks, wherein each task corresponds to a particular topic relating to one of the plurality of components installed on the computer system.

36. The computer system of claim 35, wherein the task data comprises a task configured such that aspects of a corresponding component installed on the computer may be manipulated from within the task library.

37. An integrated help system on a computer, comprising:
help information from a plurality of components installed on a computer system;
a help system library for storing the help information from the plurality of components; and
links referencing the help information from the plurality of components, wherein the links are stored with the help system library.

38. The integrated computer help system of claim 37, wherein the plurality of components installed on the computer system comprises a hardware component.

39. The integrated computer help system of claim 37, wherein the plurality of components installed on the computer system comprises a software component.

40. The integrated computer help system of claim 37, wherein the plurality of components installed on the computer system comprises operating system components.

41. The integrated computer help system of claim 37, wherein the plurality of components installed on the computer system comprises a hardware component and a software component.

42. The integrated computer help system of claim 37, wherein the plurality of components installed on the computer system comprises a remote component.

43. The integrated computer help system of claim 37, wherein the plurality of components installed on the computer system are from a plurality of component providers.

44. The integrated computer help system of claim 37, wherein the predefined schema organizes the links referencing the help information according to predefined topics.

45. The integrated computer help system of claim 37, wherein the predefined schema organizes the links referencing the help information according to an alphabetic ordering of the subject matter of the help information.

46. The integrated computer help system of claim 37, wherein the help information comprises reference data to assist a user in regard to a corresponding component.

47. The integrated computer help system of claim 37, wherein the help information comprises a plurality of reference elements, and wherein each reference element corresponds to a particular topic relating to one of the plurality of corresponding components installed on the computer system.

48. The integrated computer help system of claim 47, wherein a reference element is configured such that aspects of the corresponding component may be manipulated from within the help system library.

49. A method for executing a task on a computer without changing component context from the current component, the method comprising:
retrieving a plurality of tasks from a task library, the task library comprising a plurality of tasks from a plurality of components installed on the computer;
displaying the retrieved tasks to a user;
detecting the user's selection of a displayed task; and
executing an action associated with the selected task without changing the apparent context from the current component.

50. The method of claim 49, wherein the tasks in the task library comprise tasks from at least one software component.

51. The method of claim 49, wherein the tasks in the task library comprise tasks from at least one hardware component.

52. The method of claim 49, wherein the tasks in the task library comprise tasks from at least one software component and at least one hardware component.

53. The method of claim 49, wherein the tasks in the task library comprise tasks from operating system components.

54. The method of claim 49, wherein the tasks in the task library are organized according to a predefined schema.

55. The method of claim 49, wherein retrieving a plurality of tasks from the task library further comprises retrieving the plurality of tasks from the task library according to the current component's context.

56. The method of claim 49, wherein the retrieved tasks are displayed to a user according to a determined relevancy of the tasks.

57. The method of claim 56, wherein the retrieved tasks are displayed to a user according to a determined relevancy of the tasks, such that more relevant tasks are displayed more prominently to the user.

58. The method of claim 56, wherein the determined relevancy of the tasks is determined according to the frequency with which the user has previously selected each task.

59. The method of claim 56, wherein the determined relevancy of the tasks is determined according to the frequency with which a plurality of users have previously selected each task.

60. The method of claim 56, where determined relevancy of the tasks is determined according to computer state information.

61. A computer-readable medium bearing computer-readable instructions which, when executed, carry out the method comprising:
obtaining task data for a plurality of components installed on a computer;
storing the task data in a task library;
generating task links referencing the task data according to a predetermined schema; and
storing the task links with the task library.

62. A computer-readable medium bearing computer-readable instructions which, when executed, carry out the method comprising:
retrieving a plurality of tasks from a task library, the task library comprising a plurality of tasks from a plurality of components installed on the computer;
displaying the retrieved tasks to a user;
detecting the user's selection of a displayed task; and
executing an action associated with the selected task without changing the apparent context from the current component.
